(19) United States
(12) Patent Application Publication
(10) Pub. No.: US 2010/0257140 A1
(43) Pub. Date: Oct. 7, 2010

(54) DATA ARCHIVING AND RETRIEVAL SYSTEM

(76) Inventors: Philip John Davis, Walpole, NH (US); Joel Michael Love, Saxtons River, VT (US); Elliot Lawrence Gould, Windham, NH (US); Nathan Louis Hall, Southport, CT (US); Daniel Joseph Moore, Tucson, AZ (US)

Correspondence Address: IP LEGAL SERVICES, LLC, 1500 E. LANCASTER AVENUE, SUITE 200, P.O. BOX 1027, PAOLI, PA, 19301, US

(21) Appl. No.: 12/751,436

(22) Filed: Mar. 31, 2010

Related U.S. Application Data
(60) Provisional application No. 61/165,422, filed on Mar. 31, 2009.

(51) Int. Cl. G06F 17/00; G06F 12/00

(52) U.S. Cl. 707/661; 711/161; 707/E17.044; 711/E12.001; 711/E12.103

(57) ABSTRACT

A method and system to store and retrieve archival data and indefinitely storing the data is disclosed. By using caches and large volumes of commodity disk drives controlled in a dynamic or scheduled way, power consumption of the archive system is reduced. Archive data is transferred to the archive facility via a channel, such as electronic or physical transportation, depending on a set of customer service level parameters. Archived data is replicated to a second facility to guard against multiple device failures or site disasters. The archived data is protected from erasure by both keeping the media predominantly unpowered and disabling writing to the media once it has been filled to capacity. The system provides access to indexable host and customer-specific metadata across the entire infrastructure without powering the media. All customer archive data is segregated from all other data by residing on per customer dedicated media.

### CROSS-REFERENCE TO RELATED APPLICATIONS

This application claims the benefit of the filing date of U.S. provisional application No. 61/165,422, filed on 31 Mar. 2009, incorporated by reference herein in its entirety.

### FIELD OF THE INVENTION

This invention relates generally to the field of data archiving and, more specifically to a method and system that automatically schedules and provides storage and retrieval of archival data while simultaneously increasing the mean time to data loss to be essentially infinite and platform independent.

### BACKGROUND

This invention pertains to data that is destined for archive. Although similar to a backup, archive data has many unique attributes that provide an opportunity to optimize how that data is handled versus a data backup.

Backup is the process of copying data from “primary” to “secondary” storage for the purpose of recovery in the event of a logical, physical, accidental, or intentional failure resulting in loss or inaccessibility of the original data. Backups may contain multiple copies or recovery points of the data. In the event of data loss, the backup is used to restore one of the recovery points to the primary storage. Restoring data from a backup needs to occur in a timely fashion since the data is required for day-to-day operation.

An archive differs from a backup in that an archive is data that is identified for permanent or long-term preservation as it is no longer needed for normal business operations or development. For example, data is typically archived at the end of a project. Data targeted for archive may no longer be available from primary storage, thus freeing up the primary storage to store more day-to-day data. Because archive data is not needed on a day-to-day basis, the time to restore an archive can be a significantly longer time than is required for the restore of a backup of critical business data that is in regular use. Thus, the characteristics surrounding archive data make it uniquely eligible for placement on a storage device that can take longer to return the data. This is important because these solutions are typically considerably less expensive, and, therefore, more attractive to use to store archive data.

Typical techniques used to store archive data include optical (e.g., CD or DVD media), magnetic tape, and rotating magnetic storage (e.g., disk drives).

Currently available rotating magnetic storage solutions are very expensive due to the hardware appliance required to house the disk drive as well as the additional burdens to provide power, cooling, and floor space for the appliance. Disk drives are in general fully online in nature, and are designed to respond to a storage retrieval request immediately, greatly increasing the cost due to the significant amount of additional components required to provide power and cooling for always-on, always-available functionality. However, because disk drives have several mechanical parts, disk drives have a limited lifespan, requiring potentially frequent replacement and repair. In addition, there is a significant cost for the people required to manage and maintain the drives. Due to cost reasons, archive data is more commonly stored on optical media or tape.

Tape is less expensive than disk storage, but it has inherent shortcomings, such as the need to keep a proper tape drive in operation and good working order to read the tape through the lifetime of the archive (which could be 30 years or more), normal magnetic media deterioration (including loss of surface material or stretching), an inability or impracticality of doing regular data scrubbing (the reading and rewriting of data to restore corrupted data using error detection and correction), lack of redundant data options for the tape medium (unprotected or mirrored only), and the difficulty and unpredictability in ensuring that the correct legacy format tape drive is available in the future to retrieve the archive data. Alternatively, all of the legacy format tapes may need to be individually reread and written to a new, more current tape format on a regular basis. In addition, there is the cost to ship the tapes to and house the tapes in an off-site facility. An alternative storage facility is required to guard against the destruction of the primary site. There are also extra costs to bring the tapes back when retrieving the archive. Due to the sheer volume of tapes required for archive data, it is economically impractical to check every tape for integrity, and when checks are accomplished, it is rarely, if ever, on a regular basis. Additionally, every time a tape is read or written there is deterioration of the media and a possibility of tape damage. Tape is also limited in that it is a serial interface. To find a particular file or set of files, one or more tapes need to be read back in total, and then a search initiated to locate the desired object(s).

Optical media is less expensive than magnetic disk storage and the data stored on it is generally not affected by electrical or magnetic disruptions. However, it is slower and has lower capacity limits than magnetic disk storage. Like tape, it requires a reader to be kept in proper working condition to read the media through the lifetime of the archive (which could be 30 years or more). Optical media also suffers from similar deterioration challenges to tape, so, like tape, periodic testing is required to ensure the integrity of the optical media.

Tape and optical media solutions are not amenable to run continuous integrity checks on the data to ensure that it is recoverable. Once the data has been written to the media using a tape or optical “library” or storage management system, the tape and/or optical media is usually removed from the library and stored separately. Testing involves retrieving the tape or optical media from storage, re-inserting the media in the library, and then performing the integrity tests. Additional testing using the original application the data was intended for can be used to complete the check. This process is very time consuming and takes valuable primary storage to execute, thus, it is only done sparingly and often not typically done after the data is initially written. Thus, to guard against the possibility of bad media, companies either take on the economic burden to make many copies of the data in the hope that if one copy is faulty another copy is intact, or they risk that their single copy on unverified tape or optical media may no longer be a valid, intact copy.

To properly replicate or mirror the archive data, magnetic disk storage, magnetic tape, and optical media need to write a second copy and then store that new copy at a different location to ensure geophysical separation in case of a disaster at the first off-site location. Not only is this very costly but it also exacerbates the burden of running integrity checks on the data.

With the data storage archive market today in excess of 8 exabytes (10¹⁸ bytes) and growing 40% to 60% annually, along with regulations that require long-term archiving of data (e.g., in the United States: Sarbanes-Oxley, Graham-Leach-Bliley, HIPAA, etc.), the market is ripe for an inexpensive and robust data archival solution with a substantially indefinite lifetime.

### SUMMARY OF THE INVENTION

In one embodiment, the disclosed invention comprises a method of archiving data of a customer in one or more remote archive data stores is disclosed, comprising the steps of selecting at least one data transport channel through which to transfer archival data including the content data to the one or more archive data stores, based on at least one service level parameter associated with the customer, transferring the archival package through at least one transport channel to the one or more remote archive data stores, receiving an acknowledgment of a successful archiving of the archival package at the one or more archive data stores, and optionally deleting the content data at the data provider in response to receipt of the acknowledgment.

In another embodiment, a method of retrieving archived data of a customer through at least one or more transport channels from one or more remote archive data stores is disclosed, comprising the steps of issuing a request for retrieval of the specified content data from the one or more archive data stores, establishing the plurality of transport channels, receiving a notification of the at least one channel via which the specified content data will be received from the one or more remote archive data stores, receiving the specified content data via at least one transport channel from the archive data stores, and acknowledging receipt of content data.

In still another embodiment of the invention, a method of archiving customer data received from customer is disclosed, comprising the steps of receiving data for archiving from a customer, the data for archiving including the content data and a customer identifier, indentifying an archival storage pool dedicated to the customer, the dedicated archival storage pool being physically segregated from archival storage pools dedicated to other customers, and transferring the content data to the identified archival storage pool.

In yet another embodiment of the invention, a method of transferring archived data from a storage pool to a customer is disclosed, the method comprising the steps of receiving a request for the archived content data from the customer, the request including a customer identification and an archived content data identifier, identifying a storage pool dedicated to the customer identification, bringing the identified storage pool online to allow access to data stored on the indentified storage pool, reading the archived content data from the online, identified storage pool, and transferring the read archived content data to the customer.

In an alternative embodiment, the invention comprises an archive management system for archiving customer data, comprising an archive manager, at least one archive storage array, and a customer metadata database. The archive manager receives data for archiving from multiple customers, caches, and aggregates the data for a determinable length of time, and manages routing of the data for archiving intervals to the at least one archive storage array in response to customer data stored in the customer metadata database, thereby archiving the data.

### BRIEF DESCRIPTION OF THE DRAWINGS

The invention will be described in detail with reference to the following drawings in which like reference numerals refer to like elements wherein:

FIG. 1 is a block diagram illustrating an exemplary archival and retrieval system;

FIG. 2 is an exemplary logical flow diagram illustrating the Gateway Interface archiving flow;

FIG. 3 is an exemplary logical flow diagram illustrating the Gateway Interface retrieval flow;

FIG. 4 is an exemplary logical flow diagram illustrating the Archive Management Appliance ingestion flow; and

FIG. 5 is an exemplary logical flow diagram illustrating the Archive Management Appliance retrieval flow.

### DETAILED DESCRIPTION

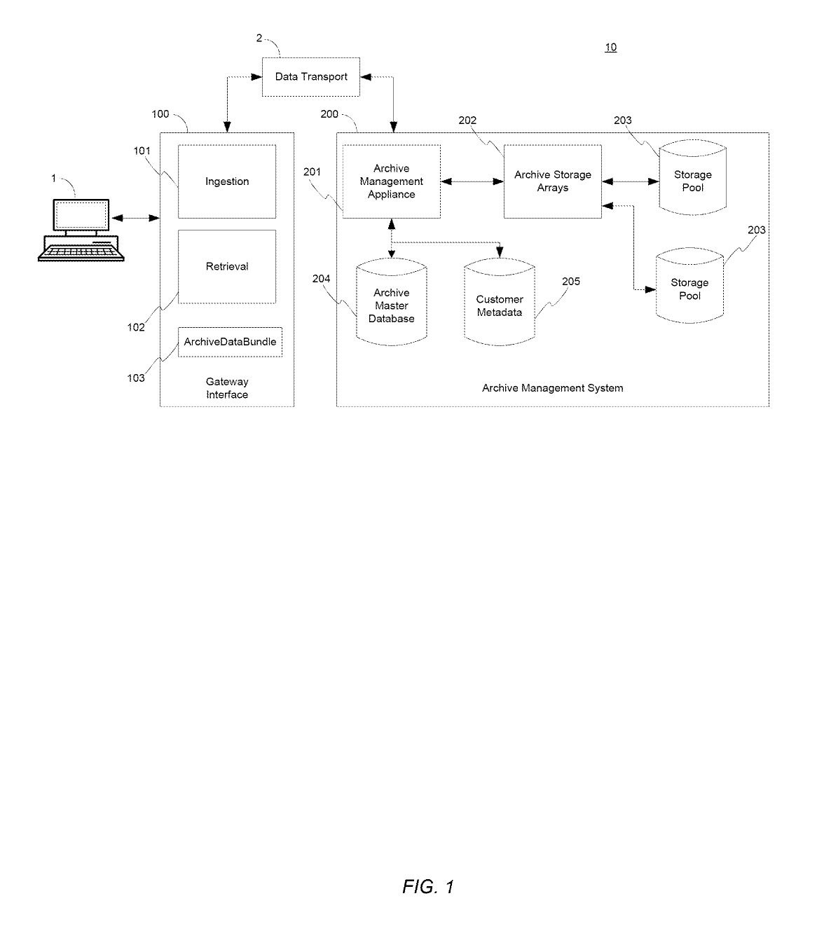

FIG. 1 is a block diagram of the archival and retrieval system 10. In this embodiment, a Gateway Interface 100 resides at the customer site running software that handles the interface between a customer and the archival and retrieval system 10. It receives the customer data targeted for archiving, optionally can compress and encrypt the data, then securely and reliably transmit it to an archive facility running the Archive Management System 200 via a bidirectional transport facility 2, e.g., an encrypted VPN connection, fiber channel, physical media transport, 802.11 system, etc. The Gateway Interface 100 has enough storage to cache a significant amount of customer data. Caching the data allows the system to efficiently manage the transfer of the data from many customer locations to an archive facility using dynamic ingestion scheduling. Should the amount of data to be archived exceed the practical limits of what the broadband connection can achieve, then the data can be written to removable media (e.g. a removable hard drive) and shipped physically to the archive facility via ground transportation 2. The customer can retrieve archived data directly from the Gateway Interface 100. If the data is no longer resident on the Gateway Interface 100, then it sends a retrieve request for the data to one or more archive facilities. If the amount of data to be retrieved exceeds the practical limits of the broadband connection, the same bulk transfer technique (i.e., writing data to removable media and shipping the physical media from the archive facility) can be exploited for data retrieval.

Customer data is delivered to the Gateway Interface 100 via a “push” model from a data management system such as a digital medical imaging archiving standard known in the art as the Picture Archiving and Communication System (PACS) or from an application running on a workstation 1 at the customer site. The application provides an optional graphical user interface to allow the customer to select objects for archiving. The application also provides an interface to allow the customer to select archived objects for retrieval. Software for the Gateway Interface 100 will also include applications and services to “pull” data destined for archive from the customer data store.

At the archive facility 200, there are two hardware subsystems, the Archive Management Appliance 201 and the Archive Storage Array 202. Customer data for archiving is received from the Gateway Interface 100 encapsulated in a standardized format or data structure called an ArchiveDataBundle 103. The ArchiveDataBundle 103 contains all the customer-specific data and metadata for all files to be archived. The Archive Management Appliance 201 is a caching appliance designed to hold (cache) all incoming data from the Gateway Interface 100 in the interim while the final archive destination of the customer's data for archiving is determined by the Archive Management Appliance 201. The time when the ArchiveDataBundle 103 is archived to the Storage Array 202 and ultimately Storage Pool 203 is chosen based on a number of variables, such as the efficiency of powering up the Storage Array 202 and Storage Pools 203. All relevant metadata from the ArchiveDataBundle 103 header file is then also copied into the high-availability customer specific metadata base 205. The Archive Management Appliance 201 then copies the ArchiveDataBundle 103 data to the Archive Storage Array 202 containing the customer's active archive Storage Pool 203.

Once all of the customer's data has been copied to the Archive Storage Array 202, the data is then sent by the Archive Management Appliance 201 to a second archive facility 200 (not shown) for replication. After replication has successfully completed, the customer's data is then considered archived.

The Gateway Interface 100 retains the original submitted copy of the customer's to-be-archived data until it has received an “Archive Complete” message from the archive facility. This model ensures that the data is fully redundant and has been archived before the archive facility accepts responsibility for the data and must adhere to the 100% data recoverability guarantee.

### The Gateway Interface

The Gateway Interface 100 is preferably a simple, low-cost, single-functionality device to simplify installation and remote maintenance. The Gateway Interface 100 preferably has at least some redundancy such as dual serial AT attachment (SATA) storage controllers, dual flash card slots (SD, CF, etc.), ECC memory, and dual network interface cards (NICs), and is designed to store all customer-specific configuration information, including customer encryption keys, stored optionally on two external flash cards.

The Gateway Interface 100 provides a simple and flexible interface for archive data that is adaptable to the customer's needs. Preferably, a user communicates with the Gateway Interface 100 using the Network File System communication protocol (NFS), other protocols, including CIFS, FTP, XAM, and NDMP, may be used as well. The Interface 100 is desirably programmable such that any implementation of a custom interface option may be implemented depending on the discovered needs of a specific customer or market.

Once the customer sends data for archiving to the Gateway Interface 100, the Gateway Interface 100 duplicates any recognized metadata from the data being archived, appends archive-specific metadata (including standard metadata such as archive date, and any agreed-upon client-defined metadata, such as a business unit), and enters this combined metadata into the Archive Master Database 204 in the archive facility 200, the Gateway Interface 100 also retaining a copy (not shown). The data being archived is first stored in the Gateway Interface 100 until it reaches a predetermined size or until a set amount of time has passed or some other predetermined event has occurred (e.g., the customer initiates the archiving), whereupon the data being archived is bundled into the ArchiveDataBundle 103 as read-only and optionally encrypted and/or compressed, making the ArchiveDataBundle 103 set for transfer to an archive facility 200.

Once the ArchiveDataBundle 103 is ready for archive, the Gateway Interface 100 then selects one of several options to transport the data, for instance over the Internet or via ground transportation. The selection is determined dynamically based on the archive data itself and customer-specific metadata stored in the Gateway Interface 100. Service level parameters in the customer-specific metadata include, but are not limited to, the speed and/or bandwidth of the customer's broadband connection, the fraction of the broadband connection dedicated to archiving, the cache size of the Gateway Interface 100, the available destinations, and the time allotted for an archive to complete. The transfer event is then scheduled by the Gateway Interface 100 through the selected transportation channels based on feedback from the remote archive facility 200, such as when the facility is ready to receive the data.

Once the Gateway Interface 100 has received an “Archive Complete” message from the archive facility, the data in its cache is marked for deletion. However, the data will only be deleted based on a cache flushing algorithm to make room for new data to be archived. This way the archive data is often available locally for rapid retrieval, if requested and still available, eliminating the need to transport the data from the archive facility back to the Gateway Interface 100.

When a customer issues a request to retrieve previously archived data, the Gateway Interface 100 first determines whether the requested data is available in its local cache. If so, then it presents the data back to the customer directly. If the data is not available in its local cache, a request is issued to the archive facility to retrieve the specified content. The Gateway Interface 100 receives notification regarding which transport channel has been selected and an expected arrival time. Upon receipt of the data, an acknowledgement is sent to the archive facility. If the expected arrival time expires, a notification is sent to the archive facility.

### Archivedatabundle Details

The ArchiveDataBundle 103 is a standard package of archive data created by the customer. Whenever an archive session starts at the customer's site, an ArchiveDataBundle 103 is created and populated with the customer's archive data. This data is stored in its original format, with the filename and full folder hierarchy (including server name) fully preserved, however the root file folder would be a uniquely-identifying session ID, generated at the initial point of ingestion, to allow the same file to be archived multiple times without a folder hierarchy conflict. A new ArchiveDataBundle 103 is created when the original ArchiveDataBundle 103 has reached a predetermined size (e.g., 10 gigabytes), or when a set amount of time has passed (e.g., one day), as the ArchiveDataBundle 103 is not submitted for archive until it has been marked read-only. An exemplary implementation of the ArchiveDataBundle 103 is based on the commonly known Zetabyte File System logical construct residing in a ZFS Storage Pool in Interface 100, which is moved between ZFS pools via the standard ZFS send/receive command set, and with each ZFS pool containing any number of ZFS filesystems/ArchiveDataBundles from the same customer. The ArchiveDataBundle 103 contains all of the customer's data, including metadata (e.g., the name of the file, size, creation date, last modification date, full path, etc.), for all files within the ArchiveDataBundle 103, as well as full original folder structure, Unique Universal ID (UUID), and archive timestamp.

### Archive Management Appliance

The Archive Management Appliance 201 is at the heart of the archive facility infrastructure, and its primary function is as the key enabler of low-power functionality for the rest of the storage environment. The Archive Management Appliance 201 takes initial receipt of the uneven flow of ArchiveDataBundles 103 from multiple customers into the archive facility 200, caches and aggregates the data for a length of time, and then manages the routing of the ArchiveDataBundles 103 at regular, algorithmically determined and/or predictable intervals to the various local and remote Archive Storage Array 202 arrays. This appliance assists in providing full data-flow management within the archive facility, and enables the Archive Storage Array 202 arrays to enable the corresponding Storage Pools 203 only at desired and/or pre-set intervals, instead of repeatedly enabling them each time data is received into the archive facility 200.

The Archive Management Appliance 201 appliance is a storage array designed to house large amounts of data in a non-comingled fashion, i.e., each customer's data is segregated onto its own storage device such as a disk drive, and it provides all archive data input and output functions by the Archive Management Appliance 201 to the various Storage Pools 203 via the exemplary ZFS send/receive command set for bulk archive and retrieval or individual file retrieval. Unlike the Archive Storage Array 202, the Archive Management Appliance 201 is an always-on device, although the overall archival/retrieval infrastructure expects and tolerates Archive Management Appliance 201 unavailability. It is understood that 100% data recoverability functionality of data archived on the Archive Storage Array 202 (no remote replication, no tolerance for double-drive failure) may not be possible. Therefore, in the event of an Archive Management Appliance 201 failure before the data is copied to the Archive Storage Array 202, the data can be pulled from the Gateway Interface 100 again, and the data should also still exist on the customer's primary storage.

The Archive Management Appliance 201 functions as the key enabler of low-power functionality for the rest of the storage environment—it is a holding area for data prior to final archive, acting as a buffer that allows reception of ArchiveDataBundles to continue while waiting for the long-term archive in the Archive Storage Arrays 202 to selectively enable the Storage Pool 203 as needed. As described in more detail below, the Storage Pools 203 advantageously comprises banks of storage units (sometimes referred to as Just a Bunch of Disks or JBOD), such as hard disks, that are selectively enabled for storing, retrieving, and integrity testing of the data stored therein. Each customer is assigned a segregated storage unit in the Archive Management Appliance 201 to ensure that the customer data is not comingled with other customer data on its way to being permanently stored on Storage Pool 203. Overall responsibilities of the Archive Management Appliance 201 include its caching function, reading all metadata from the incoming archive data and copying this data into the per-customer metadata database 205, copying the actual archive data to the local and remote Archive Storage Array 202 (whereupon the data is acknowledged as archived and replicated to the customer), scheduling, and finally all communications regarding the customer's active archive pool to the archive master server nodes, including requests for the location of the active archive pool, requests for the next power-on time of the pool, and requests to provision a new customer active archive pool once the current active archive pool has become full.

### Archive Master Database

The Archive Master Database 204 is a distributed database and directory containing the location and unique identifier of all active drive pools, all inactive/hibernated Storage Pools 203, all unconfigured/uncommitted drives, and per-customer gigabyte authorization tables indicating the amount of storage a customer has either purchased or automatically authorized additional archive capacity (and therefore whether or not additional space can be allocated for their future archive data). The Archive Master Database 204 also auto-generates unique names (consisting of, for example, the customer ID as the prefix and a sequence number as the suffix) for all new archive pools within the facility, and, upon creation, stores this name and the associated location in the active drive pool table. While a central repository for information, the Archive Master Database 204 is primarily read-only (writes usually occur when a new storage pool must be configured), allowing for horizontal scalability through multiple database copies.

### Per-Customer Metadata Database

Each customer has a metadata database assigned to it, Customer Metadata 205, which contains a copy of selected archive metadata separate from the archive metadata copy contained in the ArchiveDataBundle 103 itself, to facilitate per-file archive retrieval, and to allow for the metadata to be queried, indexed, and accessed on an ad-hoc basis without requiring the actual Storage Pools 203 to be powered on during each metadata access. The Customer Metadata 205 also provides location information for every file archived by the customer, including, for example, ArchiveDataBundle 103 name, archive Storage Pool 203 name, the local and remote Archive Storage Array 202 associated with the archive Storage Pool 203, and optional internet Small Computer System Interface (iSCSI) disk addresses for the Storage Pool 203. The capacity of Customer Metadata storage 205 can easily scale as the customer's dataset scales, from initially a single database instance to a large distributed database in a segregated configuration.

### Archive Storage Array

The Archive Storage Array 202 is the final gateway for all archive data. It, in one embodiment, connects to large numbers of SATA disk drives, the Storage Pool 203, presented to the Archive Storage Array's controller directly via SATA, over iSCSI, or similar block-level network protocol, and aggregates groups of disks together into highly-redundant pools/RAID sets or similar data protection mechanism on a per-customer basis. Each pool contains a set of disks with each pool capable of withstanding at least two disk drive failures without data loss. In addition, data from every pool is asynchronously replicated (via the exemplary ZFS send/receive command set initiated by the Archive Management Appliance 201) to a remote datacenter with a logically identically-configured pool possessing similar redundancy characteristics which ensures archived data can withstand multiple local failures or even regional disasters. The Archive Storage Array 202 presents its data back out to the infrastructure via the ZFS send/receive file system copy method, which allows the Archive Management Appliance 201 to write or retrieve archive data upon customer request. The Archive Storage Array 202 primarily deals with active Storage Pools 203—these are pools of storage, segregated per customer, which contain a certain amount of capacity for archiving data. These active pools are written to in predetermined and/or regular intervals with the incoming ArchiveDataBundles 103 (aggregated and scheduled by the Archive Management Appliance 201 cache for efficiency) until the active pool becomes full, whereupon the entire pool is marked as read-only and placed into a long-term hibernation state. In the hibernation state, the hibernated Storage Pool 203 is powered up when a data retrieval request is made or at predetermined intervals to test the integrity of the Storage Pool 203. The integrity testing is based on a number of variables targeted to maintain the specific technology used in the Storage Pool 203 (disk type, reliability timeframes, interdependencies with other drives in the system, retrieval and archive requests and operations) to test the integrity of the archive data, to check whether the drives are functional, and to check for media errors and to optimize each drive's lifespan. An exemplary method for integrity testing of the hard drives in such Storage Pools is described in “Disk Scrubbing in Large Archival Storage Systems” by Schwarz et al., published in 12th International Workshop on Modeling, Analysis, and Simulation of Computer and Telecommunication Systems, 2004, pages 409-418, and incorporated by reference herein in its entirety. In general, the Archive Storage Array 202 will only have a few active Storage Pools at one time, although it may be connected to hundreds of hibernating Storage Pools 203.

As Storage Pools reach their end of life, new Storage Pools 203 are created and the archive data on the Storage Pools 203 targeted for replacement is replicated to a new Storage Pool 203. Once the replicated archive data on new Storage Pool 203 has been verified, the original Storage Pool 203 can be destroyed. This technology refresh is handled invisibly to the customer.

### Pool Creation

Pool creation is initiated by a request from the Archive Master Database 204 once it has been notified that a customer's active Storage Pool 203 is full or a new customer has requested to archive data. The Archive Master Database 204 passes to the Archive Storage Array 202 the addresses of the set of unconfigured disk drives it determines are to be used in the new Storage Pool 203, and the name to be used for the new Storage Pool 203, consisting of the customer's ID and a sequential unique Storage Pool number. This Storage Pool is configured so that data cannot be overwritten to ensure against any attempt to overwrite the data once it has been written. Once the Storage Pool 203 becomes full, the Storage Pool 203 is flagged as read-only, powered down, and converted to an inactive/hibernated status.

### The Archive Storage Array Disk Array

The Archive Storage Array 202 is the final destination for all archive data. It is exceptionally unique in that it is the first storage array purpose-built to house infrequently-accessed archive data, unlike the “always available” primary storage arrays well known in the art. The Array 202 is designed from the perspective that the integrity of stored data is paramount and the immediate accessibility of data is of less importance.

Advantageously, the Archive Storage Array 202 array operates to realize high data storage density in a footprint that would otherwise be impractical for a traditional on-line storage techniques array due to, for example, heat concerns. This architecture also allows the Archive Storage Array 202 to operate in any room, without the expensive requirements of a temperature controlled datacenter, and in turn allows the Archive Storage Array 202 to achieve a capacity-per-watt ratio that may be significantly greater than any other known storage array technique. In addition to the low operational costs, the high density per controller and lack of high-availability components allows the Archive Storage Array 202 to be produced for low cost. When compared to the original bare per-gigabyte cost of the disk drives from the manufacturer, the Archive Storage Array 202 frame adds a relatively small overhead, as opposed to the current standard where a manufactured array's per-gigabyte cost is generally a multiple of the component disk drives volume per-gigabyte cost. The system provides quicker restoration by managing individual archival events in a more efficient manner. Data can be archived or retrieved in bulk as well as incrementally, and can be retrieved as individual files, multiple files, folders, or a combination from one or more archives. The system provides access to indexable host and customer-specific metadata across the entire infrastructure without requiring the archived drives to be powered on. The system is hardware-independent, thus making the data immune to media obsolescence and eliminating the need to keep a host of legacy drives and/or readers on hand for archive restoration. Being hardware-independent also allows for automatic, hardware-transparent data migration. This minimizes the administrative overhead and risk of component replacements due to failure or age.

Further, all customer archive data is segregated from all other data by residing on dedicated drives per customer. Since these drives independently provide all of the data necessary to recover every piece of information the customer has ever stored in the archive, the drives can be owned by the customer whose data is stored on the drive. Because each archive facility 200 is independent and self-sufficient, thus there is no single bottleneck or single point of contention throughout the archive system, and additional storage capacity at a facility 200 can be realized simply by adding additional Storage Pools 203 as needed. This customer-segregated architecture is unique in clustering architectures in that it allows for the same performance (access time) as storage capacity in the archive system scales.

The Archive Storage Array 202 is not a complex array to administer. It may be implemented using one protection type such as RAID 6 (double-parity) with remote replication provided in software by either Archive Management Appliance 201 or the Archive Storage Array 202 controller—and all customer-dedicated pools can be created from entire dedicated physical drives as opposed to highly-abstracted virtual volumes requiring shared data and complex system administration. Free Storage Pools 203 are automatically allocated on the fly as soon as a qualified customer requires additional archive space, and platform retirement and migration, a process that has typically been labor intensive, occurs automatically when a Archive Storage Array 202 is flagged for replacement. An array marked for replacement may automatically broadcast its need for replacement via the Archive Storage Array 202 controller, and available Storage Pools in the storage grid initiate a full copy and then send a power-off/node removal signal to the replaced Archive Storage Array 202 array once the copy has been successfully completed.

### Array Functionality

The functionality of the Archive Storage Array 202 itself is straightforward—it presents individual disks to the network as iSCSI targets, or directly to a dedicated Archive Storage Array controller as SATA addresses, and provides no additional hardware RAID functionality outside of drive failure detection and hot-swappable disks. Each array has no unique configuration or component as all configuration information is created and stored in software implemented in Archive Storage Array 202—this allows unconfigured drives to be a shared commodity across the entire environment for maximum utilization and minimum complexity, while drives belonging to a customer pool have no hardware-imposed configuration information and therefore can easily be accessed from a different array or even a standard open system with ZFS-mounting capabilities.

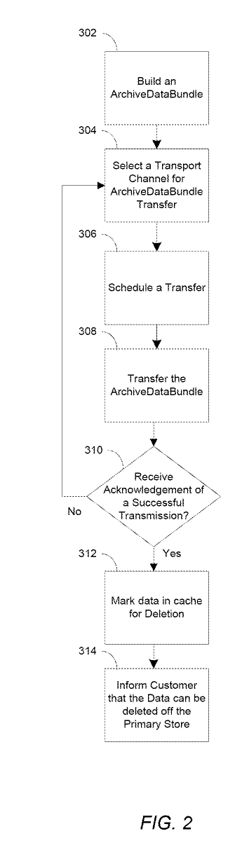

FIG. 2 is an exemplary logical flow diagram illustrating the Gateway Interface archiving flow. The description of this figure will also refer to elements in FIG. 1. In step 302 an ArchiveDataBundle 103 is created by building a package containing the received archive data, the customer metadata, and the Gateway Interface metadata. Following step 302, step 304 selects an appropriate transport channel to transfer the ArchiveDataBundle 103 based on assessing a set of parameters, including, but not limited to, the customer's service level parameters. Step 304 is followed by step 306 where the Gateway Interface schedules the transfer of the ArchiveDataBundle 103 based on a set of parameters, including, but not limited to, service level parameters, cache usage, current and expected broadband bandwidth availability, and archive facility availability. Step 306 is followed by step 308 where the ArchiveDataBundle 103 is transferred to the archive facility via the selected data transport channel 2 at the scheduled time. Step 308 is followed by step 310 where a decision to branch back to step 304 or continue on to step 312 is made based on whether or not the ArchiveDataBundle was successfully received by the archive facility. An unsuccessful acknowledgement means branching back to step 304. A successful acknowledgement means continuing on to step 312. Step 312 marks the data in the Gateway Interface cache for deletion. Step 312 is followed by step 314 where the customer is notified that the data has been archived and can now be deleted off primary storage.

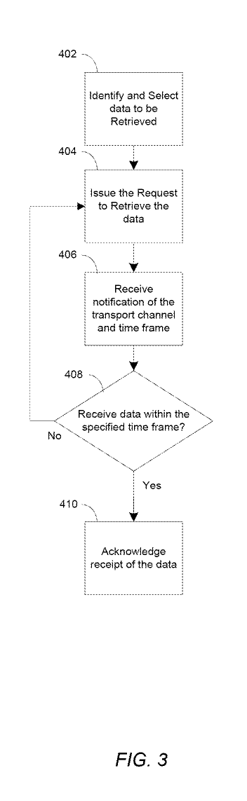

FIG. 3 is an exemplary logical flow diagram illustrating the Gateway Interface retrieval flow. The description of this figure will also refer to elements in FIG. 1. In step 402 data is identified and selected for retrieval based on the Customer Metadata. Data can be from one or more archive data Storage Pools 203. Step 402 is followed by step 404 where a request to retrieve the specified data is issued to the archive facility. Step 404 is followed by step 406 where the Gateway Interface 100 receives a notification from the archive facility 200 regarding which transport channel will be used to transport the data back to the Gateway Archive 100 and the specified time frame that the data should arrive by. Step 406 is followed by decision 408. If the data is successfully received within the specified time frame, the process continues to step 410, otherwise the process branches back to step 404. In step 410, an acknowledgement of a successful receipt of the data is sent back to the archive facility 200.

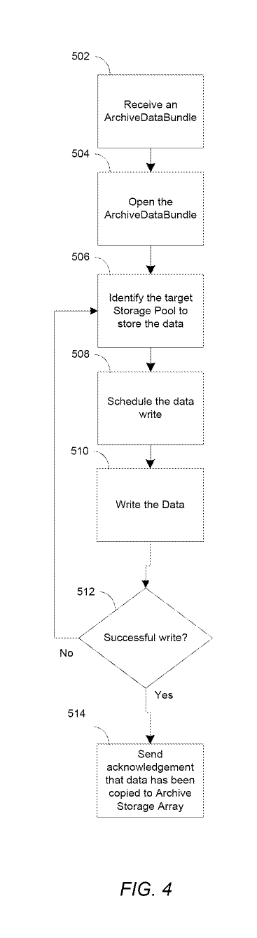

Example: FIG. 4 is an exemplary logical flow diagram illustrating the Archive Management Appliance ingestion flow. The description of this figure will also refer to elements in FIG. 1. In step 502 the Archive Management Appliance 201 receives an ArchiveDataBundle 103 from a Gateway Interface 100. Step 502 is followed by step 504 where the Archive Management Appliance opens up the ArchiveDataBundle 103 to separate out the ingested archive data, the customer metadata, and the Gateway Interface metadata. Step 504 is followed by step 506 where the target Storage Pool 203 is identified by determining via external data (from the Archive Master Database 204) whether an active customer Storage Pool 203 already exists with sufficient free space, or if not, requesting that a new active customer Storage Pool be provisioned and the previous pool be marked as inactive (hibernated). Step 506 is followed by step 508 where the Archive Management Appliance schedules the transfer of the archive data based on a set of parameters, including, but not limited to, an existing power-on schedule for the identified Storage Pool, and the read/write queue for the Archive Storage Array 202. Step 508 is followed by step 510 where the archive data is written to the active Storage Pool 203 at the scheduled time. Step 510 is followed by decision 512. If the data is successfully written to the Archive Storage Array 202, the process continues to step 514, otherwise the process branches back to step 506. In step 514 an acknowledgement of the successful data write to the Storage Pool 203 in the Archive Storage Array 202 is sent to the Gateway Interface.

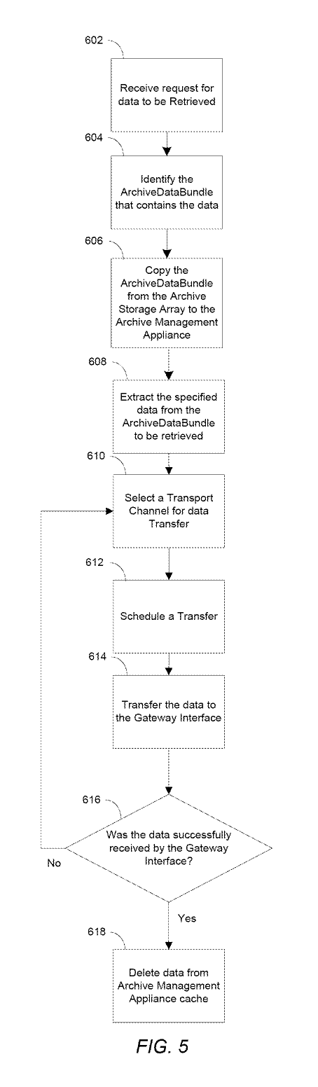

FIG. 5 is an exemplary logical flow diagram illustrating the Archive Management Appliance 201 retrieval flow. The description of this figure will also refer to elements in FIG. 1. In step 602, a request to retrieve data is received. Step 602 is followed by step 604 where the appropriate ArchiveDataBundle 103 is identified that contains the data to be retrieved based on the information stored in the Customer Metadata database 205. Step 604 is followed by step 606 where the Storage Pool 203 on the Archive Storage Array 202 containing the ArchiveDataBundle 103 is power up and the data is copied from the Storage Pool in the Archive Storage Array over to the Archive Management Appliance 201 cache. Step 606 is followed by step 608 where the specific files requested for retrieval are extracted from ArchiveDataBundle 103. Following step 608, step 610 selects an appropriate transport channel 2 to transfer the data based on assessing a set of parameters, including, but not limited to, the customer's service level parameters stored in database 205. Step 610 is followed by step 612 where the Archive Management Appliance schedules the transfer of the data based on a set of parameters, including, but not limited to, service level parameters, current and expected broadband bandwidth availability, and Gateway Interface 100 availability. Step 612 is followed by step 614 where the data is transferred to the Gateway Interface 100 via the selected transport channel 2 at the scheduled time. Step 614 is followed by step 616 where a decision to branch back to step 610 or continue on to step 618 is made based on whether or not the data was successfully received by the Gateway Interface 100. An unsuccessful acknowledgement means branching back to step 610. A successful acknowledgement means continuing on to step 618. In step 618 the data in the Archive Management Appliance 201 cache is deleted.

For purposes of this description and unless explicitly stated otherwise, each numerical value and range should be interpreted as being approximate as if the word “about” or “approximately” preceded the value of the value or range. Further, signals and corresponding nodes, ports, inputs, or outputs may be referred to by the same name and are interchangeable. Additionally, reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the terms “implementation” and “example.”

It is understood that various changes in the details, materials, and arrangements of the parts which have been described and illustrated in order to explain the nature of this invention may be made by those skilled in the art without departing from the scope of the invention as expressed in the following claims.

1. A method of archiving data of a customer in to one or more remote archive data stores, the method comprising:
selecting at least one data transport channel through which to transfer archival data including the content data to the one or more archive data stores, based on at least one service level parameter associated with the customer;
transferring the archival package through at least one transport channel to the one or more remote archive data stores;
receiving an acknowledgment of a successful archiving of the archival package at the one or more archive data stores; and
optionally deleting the content data at the data provider in response to receipt of the acknowledgment.

2. The method of claim 1, wherein the archival package is built based on combining customer metadata, gateway metadata, and the content data.

3. The method of claim 2, wherein the archival package is built based upon at least one of the following: the total size of the package, the time elapsed between archive sessions, or some predetermined event has occurred.

4. The method of claim 1, further comprising the step of scheduling a transfer event for transferring the archival package through the selected channel.

5. A method of retrieving archived data of a customer through at least one or more transport channels from one or more remote archive data stores, the method comprising:
issuing a request for retrieval of the specified content data from the one or more archive data stores;
establishing the plurality of transport channels;
receiving a notification of the at least one channel via which the specified content data will be received from the one or more remote archive data stores;
receiving the specified content data via at least one transport channel from the archive data stores; and
acknowledging receipt of content data.

6. The method of claim 5 whereby accessing a library of metadata describing archived data available to the customer and stored in the one or more remote archive data stores.

7. The method of claim 6 whereby the data within the remote archived data store includes metadata.

8. A method of archiving customer data received from customer, the method comprising:
receiving data for archiving from a customer, the data for archiving including the content data and a customer identifier;
indentifying an archival storage pool dedicated to the customer based on the customer identification, the dedicated archival storage pool being physically segregated from archival storage pools dedicated to other customers; and
transferring the customer content data to the identified archival storage pool.

9. The method of claim 8 whereby scheduling a transfer event for transferring the content data to the identified archival storage pool is based on customer metadata.

10. A method of transferring archived data from a storage pool to a customer, the method comprising:
receiving a request for the archived content data from the customer, the request including a customer identification and an archived content data identifier;
identifying a storage pool dedicated to the customer;
bringing the identified storage pool online to allow access to data stored on the identified storage pool;
reading the archived content data from the identified storage pool; and
transferring the read archived content data to the customer.

11. The method of claim 10 whereby data from different customers are segregated in different storage pools.

12. An archive management system for archiving customer data, comprising:
an archive manager;
at least one archive storage array; and
a customer metadata database;
wherein the archive manager receives data for archiving from multiple customers, caches, and aggregates the data for a determinable length of time, and manages routing of the data for archiving intervals to the at least one archive storage array in response to customer data stored in the customer metadata database, thereby archiving the data.

13. The system of claim 12, wherein the archive manager comprises a plurality of storage pools for storing the data for archiving.

14. The system of claim 13, wherein each customer's archived data is stored in separate storage pools.

15. The system of claim 13, further comprising an archive master database containing location, status, and a unique identifier for all storage pools.

16. The system of claim 15, wherein the unique identifier for each storage pool comprises a customer identification and a sequence number.

17. The system of claim 12, further comprising at least one additional archive management system having substantially identical archived data.

18. The system of claim 12, further comprising at least one gateway interface for each customer, the gateway interface providing an interface between the corresponding customer and the archive management system.
